(19) United States
(12) Patent Application Publication
(10) Pub. No.: US 2007/0189452 A1
(43) Pub. Date: Aug. 16, 2007

(54) On-Line Tool For Detection Of Solids And Water In Petroleum Pipelines

(75) Inventors: Tina Latasha Johnson, Surrey (GB); Laurence Cowie, Katy, TX (US)

Correspondence Address: CAROL WILSON;BP AMERICA INC., MAIL CODE 5 EAST, 4101 WINFIELD ROAD, WARRENVILLE, IL, 60555, US

(73) Assignee: BP CORPORATION NORTH AMERICA INC., Warrenville, IL (US)

(21) Appl. No.: 11/670,474

(22) Filed: Feb. 2, 2007

Related U.S. Application Data
(60) Provisional application No. 60/774,156, filed on Feb. 16, 2006.

(51) Int. Cl. G01N 23/14

(52) U.S. Cl. 378/53

(57) ABSTRACT

A method and apparatus for detecting compositional aspects such as sand, water, wax deposits or asphaltene deposits of a fluid in a petroleum pipeline is disclosed. A method for managing flow of a fluid in a petroleum pipeline is also disclosed. X-rays are transmitted through the petroleum pipeline and detected to generate a density gradient profile which is preferably a function of time and space. Characteristics of the density gradient profile and correlated with characteristics of the compositional aspects of interest. The method and apparatus preferably provides presence and relative amount of the compositional aspects in real-time or near real-time such that corrective action can be taken is such aspects are not in acceptable ranges.

### TECHNICAL FIELD

The present invention relates to an on-line detection tool suitable for detecting solids composition and water cut in petroleum pipelines without disrupting fluid flow. In particular, the on-line detection tool can be used in subsea infrastructure and topside facilities.

### BACKGROUND OF THE INVENTION

In the production and transport of hydrocarbon based fluids hydrocarbons are often present with water, sand, gases or other components. Additionally, components may be present in different phases. For example, a pipeline may be transporting a multi-phase fluid with an organic liquid phase, an aqueous liquid phase, a gaseous phase and solids. Often asphaltenes may be present. Asphaltenes are crude oil components generally undesirable in production and transport. Aphaltenes are typically found in suspension in the fluid initially but can precipitate adhering to each other or depositing on surfaces. This can result in blockage to lines or damage to production or transportation facilities. Significant disruptions can be caused by asphaltene depositions. Asphaltene deposition is a significant problem in high pressure and/or low temperature environments such as subsea environments. In low temperature or high pressure environments, wax which may be present in the produced fluid may also deposit onto the inner surface of a pipeline. Such wax deposition can also cause significant blockage and may lead to damage of transportation or production facilities.

Sand or other in fine particles may also be present with the hydrocarbon fluid. Sand can cause damage to pumps, valves and other production and transportation equipment. Generally, the presence of sand is dependent upon how a hydrocarbon fluid was produced and the nature of the production reservoir. For example, significant amounts of sand are more likely to be present when a hydrocarbon fluid is produced from a cased or perforated well in hard sandface reservoirs than if gravel packing is used. However, sand can also be present with hydrocarbon fluids produced in gravel pack operations which are experiencing partial or complete failure.

Water is often present in produced hydrocarbon fluids and, typically, is present as a separate phase. The presence of water in a pipeline for hydrocarbon fluid transport can significantly affect the flow dynamics. The presence of water can change the drag characteristic, corrosion dynamics and pressure within a pipeline, primarily due to the density difference between hydrocarbon fluids and water. Additionally, the presence of water significantly impacts equipment such as pumps and valves. In high pressure or low temperature environments, water can also lead to hydrate formation which can clog pipelines which disrupts flow and can damage transport and production facilities, particularly during the removal process.

Techniques exist for reducing the negative effects of asphaltenes, wax, water and/or sand through the use of chemicals, use of filters/screens, control of temperature and pressure conditions or other methods known in the art. However, the choice of techniques and its applications often depends upon the extent to which asphaltenes, wax, water and/or sand is present in the fluid. Therefore, it is desirable to be able to not only detect the presence of sand, water, wax and/or asphaltenes, but also the amounts of sand, water, wax and/or asphaltenes present in the fluid transport of petroleum product.

Methods exist for determining the composition of a fluid by sampling, intrusive prove or other similar means. However, these methods can be disruptive or may have significant delay in processing the information to provide useful results. Non-intrusive methods are desirable to avoid disruption of product flow. Acoustic devices exist for non-intrusive detection of sand in a pipeline. However, Acoustic devices are not typically effective for monitoring water production, wax deposition or asphaltene flocculation.

X-ray transmission has been used in some fields, for example, the medical field to obtain images of objects. Such images are created by the positional variation in density of the object. X-ray transmission has not been used to determine the composition of fluid in a pipelines.

### SUMMARY OF THE INVENTION

We have discovered that x-ray transmission can be used to simultaneously determine wax deposition, asphaltene flocculation and the production rate of sand and water in transport or production facilities. X-ray transmission can be performed non-intrusively or intrusively and can be used to provide a visual image of the fluid in transport or production facilities. Additionally, x-ray transmission can provide such information in real-time or near real-time so that the information can be used to better manage the production or transport. If used in more than one location, for example transport infrastructure and production facility, a flow assurance surveillance program can be put into effect to greatly improve management of an entire production and transport system. The effects of actions taken to manage the production or transport can be monitored using x-ray transmission. An x-ray transmission device can be robust enough to perform in a wide range of environments.

In one embodiment, this invention provides a method for detecting compositional aspects of fluid in a petroleum pipeline. The method comprises transmitting x-rays into a petroleum pipeline; detecting x-rays transmitted through fluid in the pipeline; generating a density gradient profile from the detected x-rays; and correlating the density gradient profile to known characteristics of compositional aspects to be determined. Optionally, the method further comprises the steps of measuring absorption spectra of the fluid; and correlating the absorption spectra to known characteristics of compositional aspects to be determined. Preferably, the method also comprises the steps of displaying a visual representation of the density gradient profile and the correlating step preferably comprises correlating the visual representation of the density gradient profile to known characteristics of compositional aspects to be determined. Compositional aspects are preferably on or more of sand, water, wax deposits, asphaltene deposits and combinations thereof.

In other embodiments, this invention provides a method of managing flow in a petroleum pipeline. The method comprises transmitting x-rays into a petroleum pipeline; detecting x-rays transmitted through the pipeline; generating a density gradient profile from the detected x-rays; correlating the density gradient profile with predetermined characteristics of compositional aspects; and determining whether the predetermined compositional aspects are within acceptable ranges. Preferably, the method also comprises the steps of taking corrective action; retransmitting x-rays into the petroleum pipeline; detecting x-rays retransmitted through the pipeline; generating an additional density gradient profile from the detected retransmitted x-rays; correlating the additional density gradient profile with the predetermined characteristics of compositional aspects; and determining whether the predetermined compositional aspects are within acceptable ranges.

In other embodiments, this invention provides a device for detecting compositional aspects of fluid in a petroleum pipeline. The device comprises an x-ray transmitter adapted to transmit x-rays into an operational petroleum pipeline; an x-ray detector adapted to detect x-rays transmitted from the x-ray transmitter; a processing unit in communication with the x-ray detector adapted to create a representation of a density gradient profile; and a visual output device in communication with the processing unit. Preferably, the x-ray detector comprises a fluorescent surface. Preferably, the device can further comprise a camera for capturing visible energy emitted by the fluorescent surface. Optionally, the processing unit is adapted to correlate characteristics of a density gradient profile with characteristics of predetermined compositional aspects of fluid in the petroleum pipeline. Preferably the predetermined compositional aspects include one or more of sand, water, wax deposits, asphaltene deposits and combinations thereof.

### BRIEF DESCRIPTION OF THE DRAWING

FIGS. 1 through 12 illustrate visual images and representations of density gradient profiles of fluid obtained using x-ray transmission. The information can be used to identify characteristics for future in correlating with characteristics of observed density gradient profiles.

FIG. 13 a representation of the detection tool set up for use on a petroleum pipeline.

### DESCRIPTION OF THE PREFERRED EMBODIMENT(S)

While this invention is susceptible of embodiment in many different forms, there will herein be described in detail, specific embodiments of the invention. It should be understood, however, that the present disclosure is to be considered an exemplification of the principles of the invention and is not intended to limit the invention to any specific embodiment so described.

As used herein, “pipeline” means a pipeline or similar device for the transport of fluids where the fluid flows along the device. Pipeline includes tiebacks, risers, flowlines, export lines and other apparatus for the transport of fluids, including apparatus for transport within a facility, for example a refinery or chemical plant and including branches or sampling lines thereof. As used herein, “petroleum pipeline” means a pipeline for transporting petroleum, petroleum associated products and petroleum derived products for example crude petroleum, processed petroleum, refined fuel or fuel components, natural gas, petrochemicals, combinations of such products and combinations of such products with other products.

X-ray transmission has not previously been used to determine the composition of fluids in a pipeline for a number of reasons including the variable and complex composition of such fluids, the difficulty of analyzing flowing fluids and the belief that it could not provide advantage over existing acoustic, electric or other methods. Furthermore, it was not appreciated that x-ray transmission could be used to used to identify specific components which may be simultaneously present in the fluid. Additionally, it was not appreciated that multiple components could be identified and measured simultaneously.

We have discovered that x-ray transmission can be used to measure the presence and even amounts of various components in fluids flowing in a petroleum pipeline. In particular, x-ray transmission can be used to identify and quantify the presence of sand and water as well as asphaltene flocculation and wax deposition. Additionally, x-ray transmission can be used to identify and quantify the presence of gases, metals and other components which can provide information useful in managing infrastructure, flow and source facilities. For example, x-ray transmission can be used to detect the presence of hydrogen sulfide which affects corrosion dynamics and provides valuable information about changing characteristics of the fluid source. As further example, the presence of metals such as iron or magnesium can indicate an increased corrosion rate. As additional example, x-ray transmission can be used to identify and quantify the presence of resins, asphaltenes and oils in bitumen processes.

In one embodiment, this invention provides a method of detecting compositional aspects of fluids within a petroleum pipeline. As used herein, “compositional aspects” means physical composition features including, without limitation, amount and types of phases present, amount and types of solids or other components present, amount of water present and other similar features.

X-ray transmission is used to obtain density gradient profiles which can be correlated to characteristics of compositional aspects of fluids within a petroleum pipeline. Monochromatic x-rays can be used but preferably, polychromatic x-rays are used. Any suitable x-ray transmission source can be used but preferably a source emitting x-rays in the range from about 10 nm or less. In one embodiment, x-rays used are in the K, L and M bands. In another embodiment, x-rays in the K band are used. The x-ray source can be any source capable of transmitting x-rays in the desired ranges. Tungsten is an example of a suitable x-ray source. Other suitable x-ray sources include rhenium, ytterbium, terbium, neodymium, or other sources or even combinations of sources, capable of emitting x-rays in the desired range.

X-rays are transmitted into the petroleum pipeline and the intensity of the x-rays transmitted through the pipeline fluid is measured. The x-ray transmission intensity and the intensity pattern will vary in accordance with the density of the fluid and the presence of particles in the fluids. Absorption spectra can also be acquired to provide additional information on the molecular species present in the pipeline.

X-ray transmission intensity can be measured in any way known in the art but is preferably measured using a fluorescent surface which reacts to the transmitted x-rays. Other sensing apparatus can be employed as long as the apparatus can detect the presence of the transmitted x-rays and intensities and the intensities of the detected x-rays.

A signal is captured from the x-ray sensing apparatus and is sent directly or indirectly to a processing unit. The nature of the signal will vary in accordance with the specific x-ray sensing apparatus used. In some embodiments, a fluorescent surface is used as the x-ray sensing apparatus and the signal is a visual image of the fluorescence pattern. The signal can be digital or analog and may be compressed or transformed using various algorithms and methods used in the art. The signal may pass through other devices where it can be manipulated before being received by the processing unit. For example, the signal may be converted from analog to digital or can be compressed or otherwise manipulated or acted upon and even partially processed prior to being received by the processing unit.

The processing unit can be a computer processor of the kind known in the art. Preferably, the processing unit is a computer capable of correlating characteristics of the signals to characteristics exhibited by compositional aspects of the pipeline fluid. However, the processing unit can simply provide a rendering of the signal information for correlating by other processors or human operators.

Preferably, the processed information is provided is real-time or near real-time taking into consideration the location of the detection point relative to the location of the operator. Preferably, the processed information can be used to manage flow within the pipeline and take corrective actions to mitigate potential problems. Typically such real-time or near real-time is not more than about 60 minutes, preferably no more than 30 minutes, more preferably less than about 10 minutes.

The processed information is correlated with known characteristics of the fluid compositional aspects being analyzed. For example, the behavior of x-rays transmitted through water is different than x-rays transmitted through produced petroleum or natural gas. Additionally, transmitted x-rays behave differently when asphaltene deposits or sand is encountered. Using known or predetermined behavioral characteristics, the processed information can be correlated with identifiable characteristics of compositional aspects to identify the presence of water, sand, asphaltene flocculation, wax deposition or other desired compositional aspects. Preferably, the information is correlated to indicate the amount of such compositional aspects present.

In some embodiments, x-ray transmission data is used to generate density gradient profiles for the fluid in the pipeline. The density gradients are typically calibrated using densities of known compounds, for example toluene, decane, reference petroleum compounds or other known compounds. The density gradient profiles are correlated to density gradient characteristics of sand, water, asphaltenes, or other compositional aspects. By correlating characteristics of the detected density gradient profile to the characteristics of density gradient profiles of compositional aspects of interest, the presence and relative amount of such compositional aspects may be determined.

In some embodiments, x-ray transmission is used to obtain time variant density gradient profiles of fluid in a petroleum pipeline. Characteristics of such time variant density gradient profiles are correlated to density gradient profiles of compositional aspects of interest.

X-ray transmission can be performed without disrupting operation of a pipeline or fluid flow. Advantageously, x-ray transmission can be employed in high pressure or low temperature environments such as subsea environments.

Characteristics of compositional aspects for correlation with the observed density gradient profiles can be determined in advance and can typically be used for a variety of fluids having similar major components. To obtain characteristics of compositional aspects of interest for purposes of correlation, x-ray transmission can be performed on samples having known amounts of the compositional aspects of interest. Such x-ray transmission should be performed on still samples, stirred samples, and settling samples to identify the behavior of the transmitted x-rays and the density gradient profiles obtained. The observed density gradient profiles of the samples can then be compared to identify characteristics for use in future correlations.

In some embodiments, this invention provides a device for detecting compositional aspects of fluid in a petroleum pipeline. The x-ray transmitter of the device is adapted to transmit x-rays into a pipeline. The x-ray transmitter can be any x-ray source capable of transmitting x-rays through the pipeline and fluid. The x-ray detector of the device is adapted to detect x-rays transmitted through the pipeline from the x-ray transmitter. Any detection apparatus capable of detecting the relative intensity of the x-rays as a function of spatial position can be used. Preferably, the detection apparatus is capable of detecting the relative intensity of the x-rays as a function of time as well as space. In some embodiments, the x-ray detector includes a fluorescent surface capable of emitting electromagnetic energy of different wavelength than the transmitted x-rays which emitted electromagnetic energy is emitted in intensities varying with the intensity of the detected x-rays. Preferably, such a fluorescent surface emits visible light in response to the x-rays contacting the fluorescent surface.

A processing unit receives a signal from the x-ray detector and converts the signal into a representation of a density gradient profile. There may be other intervening apparatuses between the x-ray detector and the processing unit. For example, the signal may be compressed, converted from analog to digital, encrypted or otherwise manipulated. The processing unit may itself may be a combination of several devices but typically includes at least one processor such as a computer processor. For example, the processing unit may include a detector for detecting a signal from the x-ray detector.

In embodiments where the x-ray detector emits visible energy in response to detected x-rays, a device for visually capturing the emitted visible energy is preferably used, for example a camera, preferably a video camera. Alternatively, in such embodiments, an array of photo-detectors can be used or other methods to capture emitted visible energy can be used.

Preferably, a computer is used either as part of the processing unit or in addition to the processing unit. The computer can be used to analyze the captured density gradient profile and correlate characteristics of the captured density gradient profile with characteristics of compositional aspects of interest thereby either identifying the presence, and preferably relative amounts, of the compositional aspects of interest or facilitate such identification by an operator.

In some embodiments, some components of the device are located remotely from other components although such remote location may range from close proximity to very distant. In some embodiments, some steps of the method are separated in time and/or space from other steps of the method. For example, in some embodiments, correlation of captured density gradient profiles may take place using a computer receiving a wireless signal. For example, such computer may be in a proximate operator's station or may be in a distant control center. Such wireless signals may be any signal capable of wirelessly relaying information, for example wi-fi, traditional radio signals or telecommunications signals. Such signals may be transmitted continuously, intermittently and may include intervening transceivers which may relay the information wirelessly or via wires. The nature of the communications methods will vary in accordance with the particular application of the method or device. In some embodiments where band-width is limited, correlation does not take place remotely but the results are transmitted wirelessly to another location.

FIGS. 1 through 6 illustrate observed density gradient profiles of sample fluids in vials. In each of FIGS. 1-6, the top image is the sample vial on its side with the base of the vial on the left and the top of the vial on the right. The middle image of each of FIGS. 1-6 provides apparent density data as a function of vial elevation relative to two reference hydrocarbons (toluene and decane) and is presented in a scale corresponding to the image of the sample vial. The bottom image of each of FIGS. 1-6 presents the average transmitted x-ray intensity as a function of vial elevation.

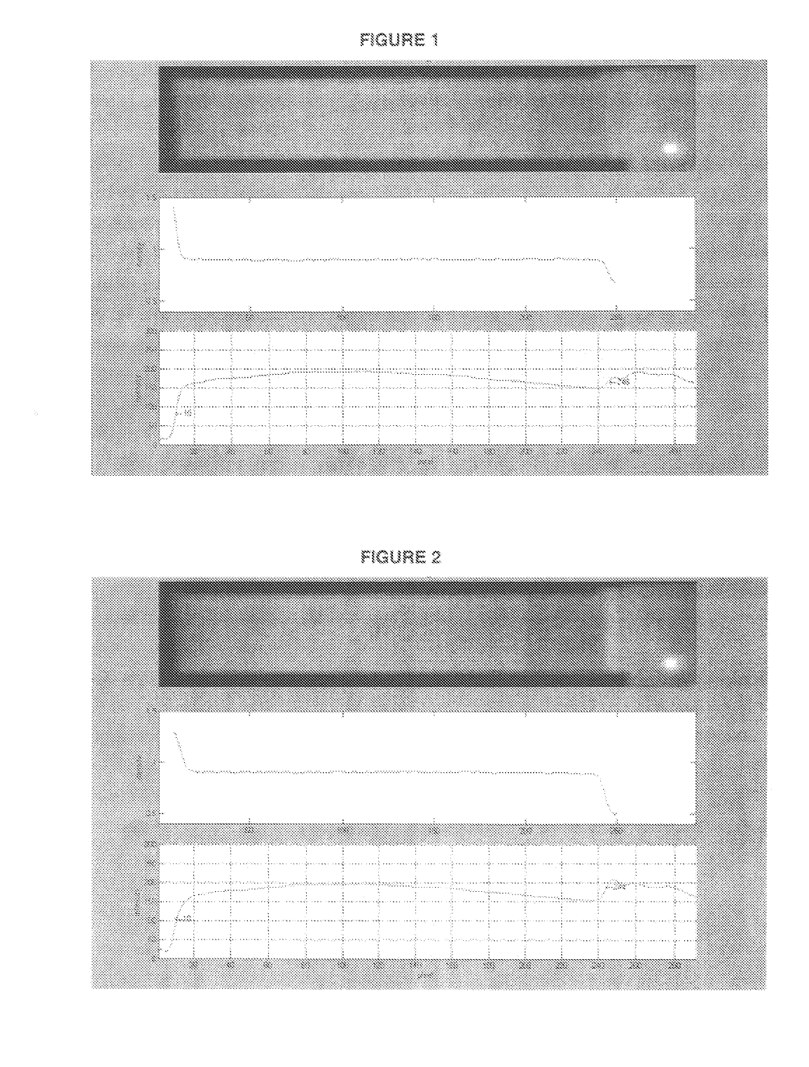

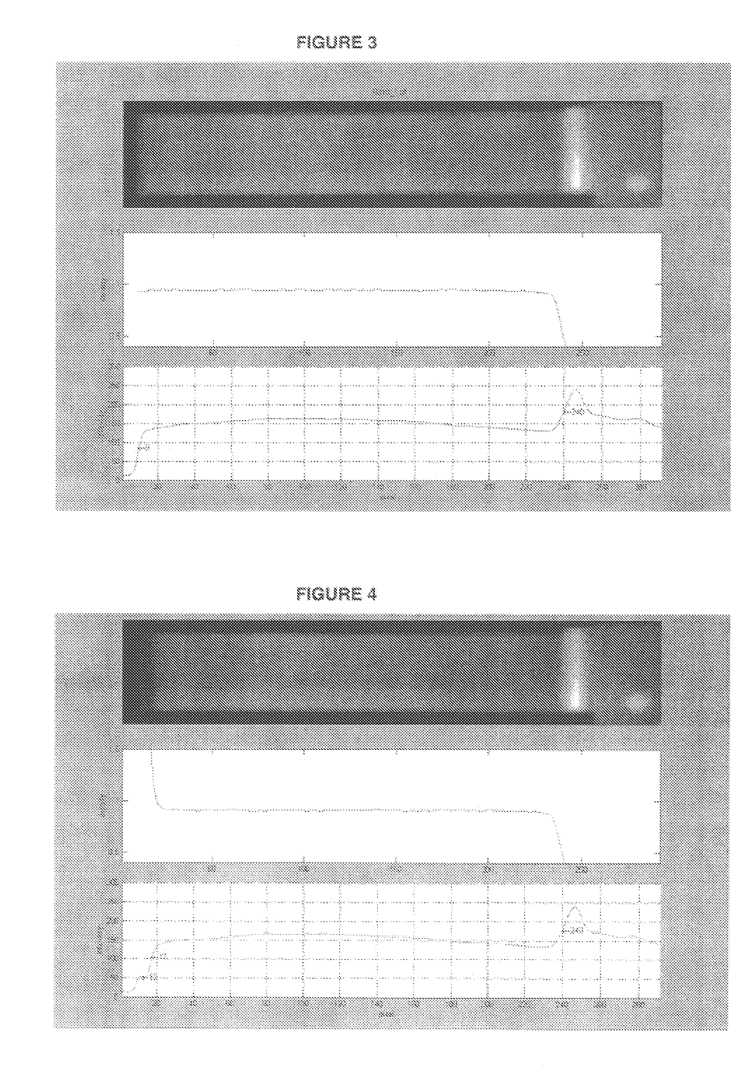

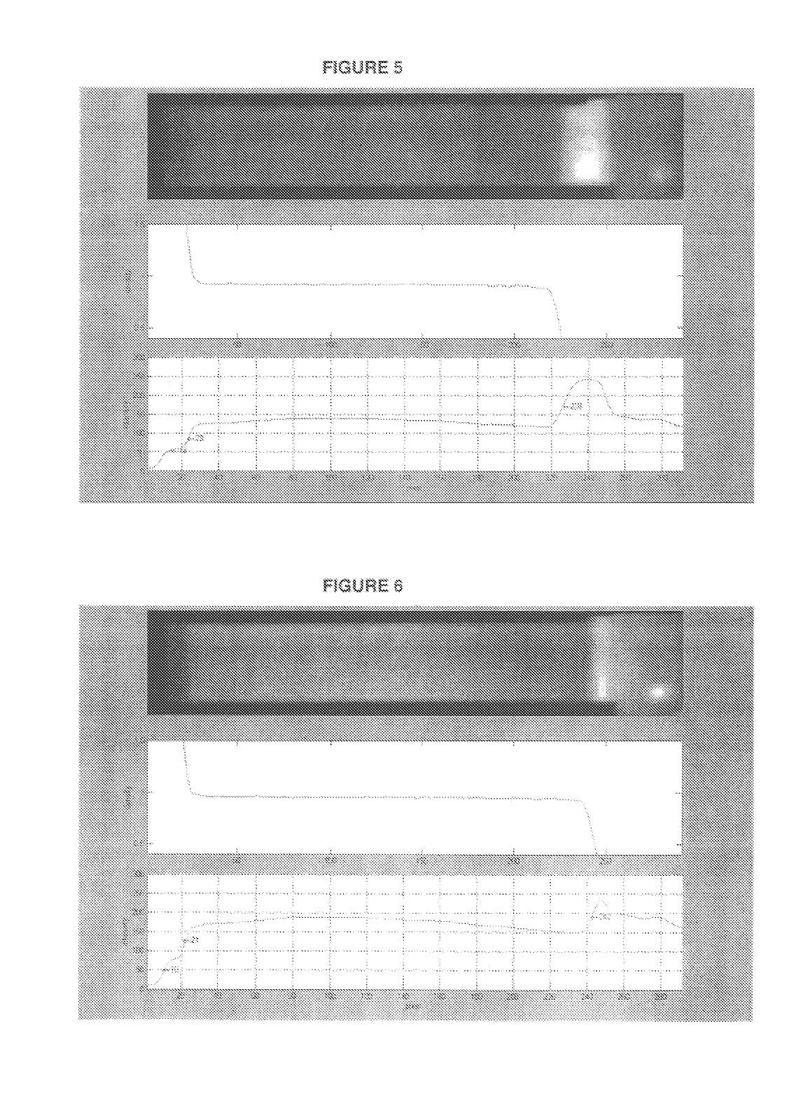

FIGS. 1 and 3 illustrate base case fluids without any significant presence of sand, water, or other solid components. FIG. 2 exhibits a deposit which adheres to the bottom of the sample via. In FIG. 4, a two-layer deposit was observed. In FIG. 5, a two-layer deposit which includes large dense particles was observed. Water was also observed beneath the organic phase and water in oil emulsion was observed. In FIG. 6, a two layer deposit of a layer comprising water and a layer comprising sand and water-in-oil emulsion was observed.

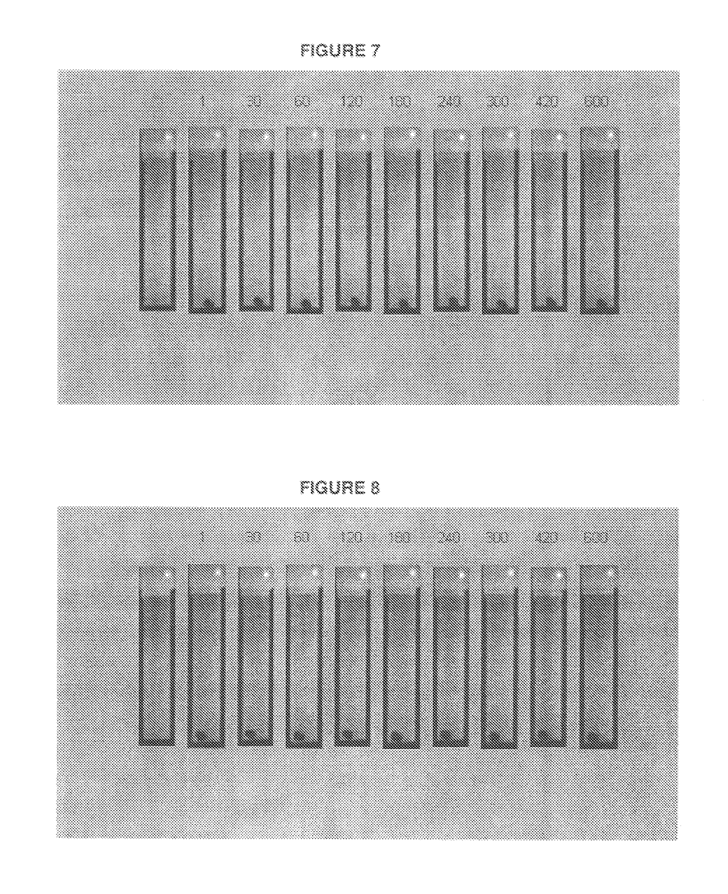

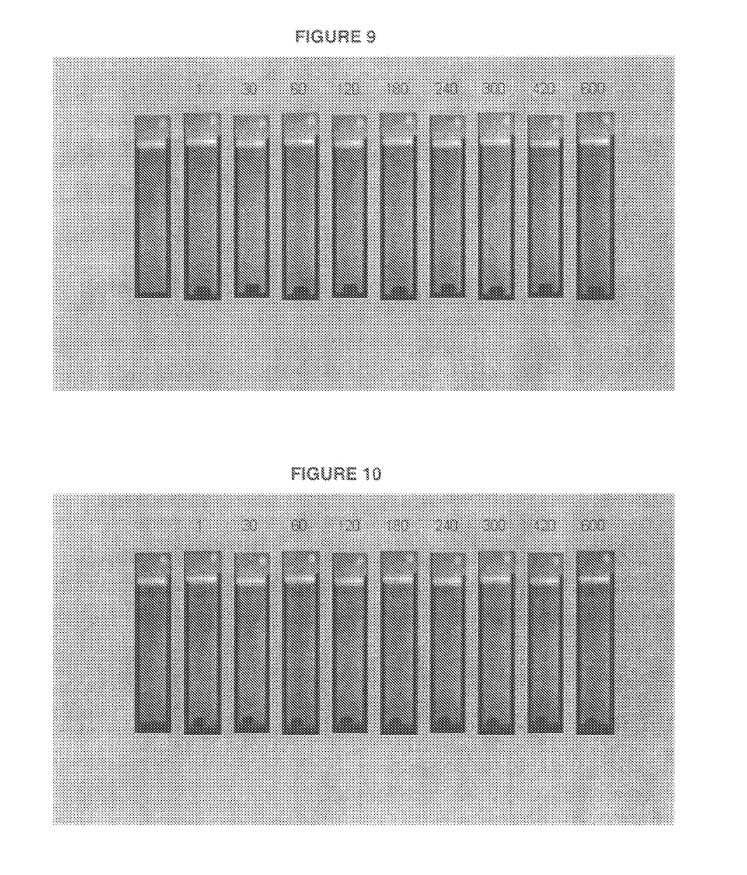

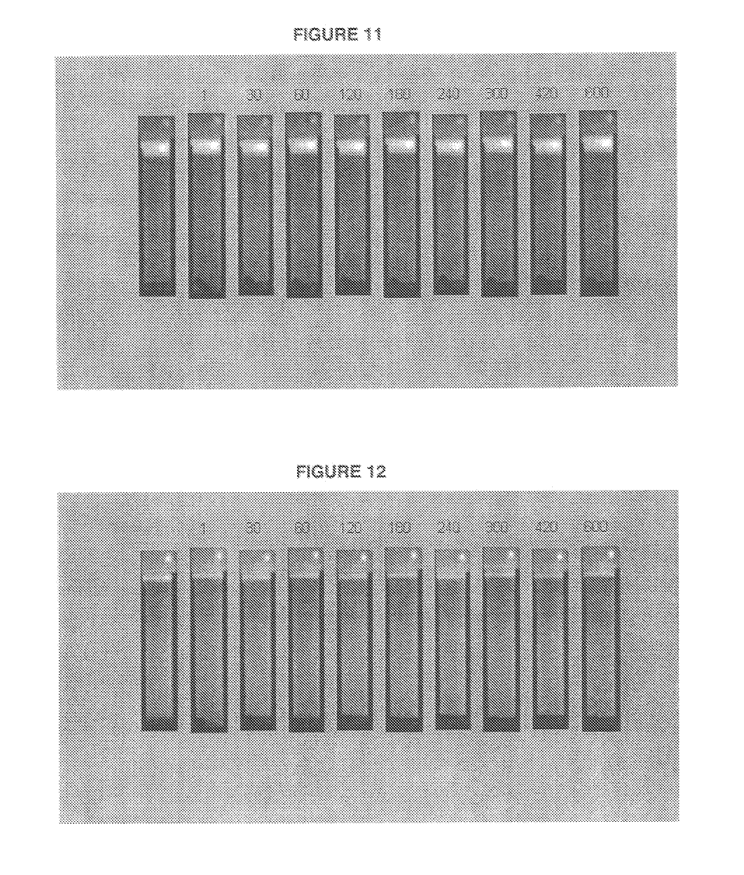

FIGS. 7 through 12 illustrate time-series x-ray transmission images of samples which were agitated for 10 minutes. The images start with an image of the still sample and then after agitation when the stirrer was turned off (1) and thereafter at the times indicated in seconds. FIGS. 7 and 9 correspond to the vials of FIGS. 1 and 3 respectively. FIG. 8 corresponds to the vial of FIG. 2. FIG. 10 corresponds to the vial of FIG. 4. FIGS. 11 and 12 correspond to FIGS. 5 and 6 respectively.

In FIGS. 1, 3, 7 and 9, no time variation was observed indicated in the absence of water or solids. In FIG. 8, the deposit which adhered to the bottom of the vial did not disperse which is consistent with asphaltene deposits. In FIG. 10, a portion of the dual layer on the bottom disperses and resettles which, in combination with FIG. 4 indicated the presence of water and asphaltene deposits. In FIG. 11 the partial dispersion and settling, in combination with FIG. 5, indicated the presence of water, sand and asphaltene deposits. The dispersion and settling observed in FIG. 12, in combination with FIG. 6, indicated the presence of water and sand.

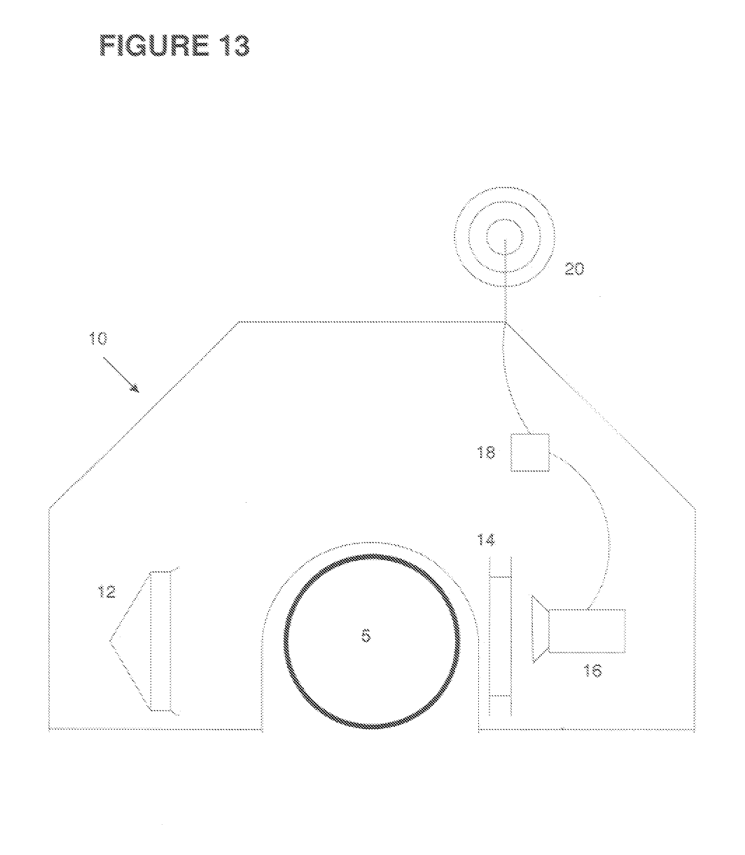

FIG. 13 illustrates an embodiment of an on-line detection device provided by this invention. Housing 10 of the device is aligned with the pipe 5 of interest. Housing 10 can be made to withstand extreme temperatures and pressures and can be externally lined with materials, for example stainless steel or titanium, to resist damage from corrosive environments. The housing may also contain a power source or an external power source can be used. Preferably, all or a portion of the housing will be lined or partly filled with lead or similar material to limit undesired exposure to x-rays. X-ray transmitter 12 is adapted to transmit x-rays into the pipeline 5. Transmitted x-rays are detected by x-ray detector 14. In the illustrated embodiment, x-ray detector 14 is a fluorescent surface which emits visible light in response to the relative intensity of x-rays contacting the detector surface. Video camera 16 is positioned to capture the image of the fluorescent surface. Converter 18 converts signals from the video camera 16 a format appropriate for transmission to a remote location. If the video camera 16 is an analog device, then converter 18 can optionally convert the analog signal to a digital signal. Preferably, converter 18 compresses and encrypts the signal. In the illustrated embodiment, wireless signal transmitter 20 transmits the signal to a remote processing unit. Alternatively, a processing unit may be either within or connected to the housing. Preferably, wireless signal transmitter 20 transmits the signal to another location for processing by a computer which converts the signal to a representation of a density gradient profile, preferably the computer also identifies and correlates characteristics of the observed density gradient profile with characteristics of compositional aspects of the fluid in the pipeline. The device may be structured differently and may be in more or less pieces and contain additional apparatuses. For example, the housing for the x-ray transmitter may be distinct from the housing for the x-ray detector. Additionally, signals may be transmitted electrically, electromagnetically or in any other way known in the art. Preferably the device is transportable.

From the foregoing description, it will be observed that numerous variations, alternatives and modifications will be apparent to those skilled in the art. Accordingly, this description is to be construed as illustrative only and is for the purpose of teaching those skilled in the art the manner of carrying out the invention. Various changes may be made in the design of the apparatus or the application of the method. Steps of the method may be performed continuously or distinctly and may be separated by time and location. For example, x-ray transmission and detection may be performed at the site of the pipeline and the information may be processed and correlated in a remote location. As further example, alternative x-ray sources may be used and various detection apparatuses, communications apparatuses and processing apparatuses can be used.

Thus, it will be appreciated that various modifications, alternatives, variations, and changes may be made without departing from the spirit and scope of the invention as defined in the appended claims.

That which is claimed is:

1. A method for detecting compositional aspects of fluid in a petroleum pipeline, the method comprising:
a) transmitting x-rays into a petroleum pipeline;
b) detecting x-rays transmitted through fluid in the pipeline;
c) generating a density gradient profile from the detected x-rays; and
d) correlating the density gradient profile to known characteristics of compositional aspects of interest.

2. The method of claim 1 further comprising the steps of:
e) measuring absorption spectra of phases present; and
f) correlating the absorption spectra to the known characteristics of compositional aspects of interest.

3. The method of claim 1 further comprising the step of displaying a visual representation of the density gradient profile; and where, in step (d), the visual representation of the density gradient profile is correlated to the known characteristics of compositional aspects of interest.

4. The method of claim 1 wherein the compositional aspects of interest comprise compositional aspects selected from the group consisting of sand, water, wax deposits, asphaltene deposits and combinations thereof.

5. A method of managing flow in a petroleum pipeline, the method comprising the steps of:
a) transmitting x-rays into a petroleum pipeline;
b) detecting x-rays transmitted through the pipeline;
c) generating a density gradient profile from the detected x-rays;
d) correlating the density gradient profile with known compositional aspect characteristics to determine a compositional aspect of fluid in the petroleum pipeline; and
e) determining whether the determined compositional aspect of the fluid is within acceptable ranges.

6. The method of claim 4 further comprising the step of:
f) taking corrective action to bring the determined compositional aspect of the fluid within the acceptable ranges;
g) retransmitting x-rays into the petroleum pipeline;
h) detecting x-rays retransmitted through the petroleum pipeline in step (g);
i) generating an additional density gradient profile from the detected retransmitted x-rays of step (h);
j) correlating the additional density gradient profile of step (i) with the known compositional aspect characteristics to re-determine the compositional aspects of the fluid in the petroleum pipeline; and
k) determining whether the re-determined compositional aspect of step (j) is within the acceptable ranges.

7. A device for detecting compositional aspects of fluid in a petroleum pipeline comprising:
a) an x-ray transmitter adapted to transmit x-rays into an operational petroleum pipeline;
b) an x-ray detector adapted to detect x-rays transmitted from the x-ray transmitter;
c) a processing unit in communication with the x-ray detector adapted to produce an output signal that is a representation of a density gradient profile; and
d) a visual output device receiving the output signal adapted to depict a visual representation of the density gradient profile.

8. The device of claim 7 wherein the x-ray detector comprises a fluorescent surface.

9. The device of claim 8 wherein the processing unit comprises a camera adapted to capture visible energy emitted by the fluorescent surface.

10. The device of claim 7 wherein the processing unit is programmed to correlate characteristics of a density gradient profile with predetermined compositional aspect characteristics to determine a compositional aspect of fluid in the petroleum pipeline.

11. The device of claim 10 wherein the determined compositional aspect comprises a compositional aspect selected from a group consisting of sand, water, wax deposits, asphaltene deposits and combinations thereof.

12. The method of claim 1 further comprising the step of displaying a visual representation of the density gradient profile; and wherein step (d) comprises correlating the visual representation of the density gradient profile to the known characteristics of compositional aspects of interest.
